(19) United States
(12) Patent Application Publication
(10) Pub. No.: US 2018/0142548 A1
(43) Pub. Date: May 24, 2018

(54) MULTIPOINT MEASUREMENTS FOR WELLBORE RANGING

(71) Applicant: HALLIBURTON ENERGY SERVICES, INC., Houston, TX (US)

(72) Inventors: Burkay DONDERICI, Houston, TX (US); Akram AHMADI KALATEH AHMAD, Houston, TX (US)

(73) Assignee: HALLIBURTON ENERGY SERVICES, INC., Houston, TX (US)

(21) Appl. No.: 15/736,184

(22) PCT Filed: May 3, 2016
(86) PCT No.: PCT/US2016/030568

§ 371 Date: Dec. 13, 2017

(51) Int. Cl. E21B 47/022; G01V 3/28

(52) U.S. Cl. CPC E21B 47/02216; E21B 47/024; G01V 3/28

(57) ABSTRACT

A system for well comparison, comprising at least one electromagnetic field generator shaped for insertion into a first well and capable of generating an electromagnetic field; at least one detector capable of measuring in the second well the field generated in the first well; wherein the first well is substantially perpendicular to the second well; and wherein measurements of the field of the at least one generator are capable of being used to calculate a distance, direction or curvature of the second well with respect to the first well.

### FIELD

The present disclosure relates generally to wellbore ranging. In particular, the subject matter herein generally relates to the downhole insertion of signal transmitters in a first wellbore, the downhole assertion of signal receivers in a second wellbore and using the differences in the received signals to calculate spatial characteristics of the second wellbore such distance, direction and curvature as they relate to the first wellbore.

### BACKGROUND

Wellbores are drilled into the earth for a variety of purposes including accessing hydrocarbon bearing formations. A variety of downhole tools may be used within a wellbore in connection with accessing and extracting such hydrocarbons. Throughout the process, it may become necessary to calculate spatial characteristics of new wellbores in relation to already drilled wellbores.

Many extraction applications call for the drilling of multiple wellbores in relative proximity to each other. Knowing how the wellbores relate to each other spatially, for example their relative distance from each other, the specific direction of that separation, and the respective curvatures of the wellbores themselves, is important to the efficient and safe distribution of wellbores within an extraction environment.

Downhole tools are commonly run into the wellbore on a conveyance such as a wireline, work string or production tubing. Such methods can be used for the insertion of transmitters or receivers into wellbores. Once in place, a transmitter placed in a first wellbore can generate a signal, and a receiver in a second wellbore can receive that signal. These signals can be used to calculate the spatial characteristics of the wellbores in relation to each other.

### BRIEF DESCRIPTION OF THE DRAWINGS

Implementations of the present technology will now be described, by way of example only, with reference to the attached figures, wherein:

FIG. 1 is a diagram illustrating an exemplary environment for a well comparison assembly according to the present disclosure;

FIG. 2 is a diagram illustrating an exemplary environment for a well comparison assembly with substantially parallel well bores;

FIG. 3 is a diagram illustrating an exemplary environment for well comparison assembly with substantially parallel well bores and arrays of transmitters and receivers;

FIG. 4A is a diagram of an example transmitter according to the present disclosure;

FIG. 4B is a diagram of the magnetic fields of an example transmitter according to the present disclosure;

FIG. 5 is a graphic display of example measurements using a well comparison assembly with substantially parallel well bores;

FIG. 6 is a workflow diagram using an example method according to the present disclosure;

FIG. 7 is a diagram illustrating an exemplary environment for well comparison assembly with well bores having curvature.

FIG. 8 is a diagram illustrating an exemplary environment for well comparison assembly with substantially perpendicular well bores and arrays of transmitters and receivers;

FIG. 9 is a workflow diagram using an example method according to the present disclosure;

FIG. 10 is a graphic display of example measurements using a well comparison assembly with substantially perpendicular well bores;

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Disclosed herein are methods of calculating spatial characteristics of new wellbores in relation to already existing wellbores, and systems for employing these methods. The methods as disclosed herein include transmitting a signal from a transmitter or transmitters introduced into a first wellbore, and receiving that signal at a receiver or receivers introduced into a second wellbore. The methods further include comparing these received signals in order to calculate the spatial characteristics of the second well such as, but not limited to, its distance from the first well, its direction from the first well, and its curvature as compared to the first well.

Also disclosed herein are systems capable of implementing the disclosed methods. For example, a transmitter or transmitter array can be introduced into a first, completed wellbore. This array comprised of multiple transmitters spaced from each other along the longitudinal axis of the wellbore. This example array would then be capable of simultaneously transmitting signals from a plurality of locations along the longitudinal axis of the wellbore. The system can be further comprised of a one or more receivers introduced into a second well. This example receiver would then be capable of receiving the transmitted signals of the axially-spaced transmitters. These received signals could then be compared and used to calculate spatial characteristics of the second wellbore as it relates to the first wellbore.

Example systems are capable of calculating these spatial characteristics in multiple different wellbore arrangements. In one example system, the intended path of the second wellbore is substantially parallel to the first, completed wellbore. Such a system could include an array of two or more transmitters introduced into the first wellbore, and one or more receivers introduced into a second, new wellbore.

In another example system, the intended path of the second wellbore is substantially perpendicular to the path of the first, completed well bore. In such a system, one or more transmitters could be inserted into the first, completed well bore, and one or more receivers could be introduced into the second, new wellbore.

The methods and systems disclosed herein may be used with any suitable transmitter (such as an electromagnetic transmitter) of any one of the commonly known types. For example, the transmitters may be coils or solenoids of the single or multi-axis type. In addition, the generation of the signals can be accomplished by any one of the commonly known methods. For example, the signal could be generated by energizing the transmitter with direct or alternating current. In addition, the receivers in the methods disclosed herein may be any one of the commonly known types. For example, the receivers could be single or multi-axis magnetometers. One of ordinary skill in the art will understand that the methods and systems disclosed herein are not limited to any one specific type transmitter or signal generation, nor are the limited to any one specific type of receiver.

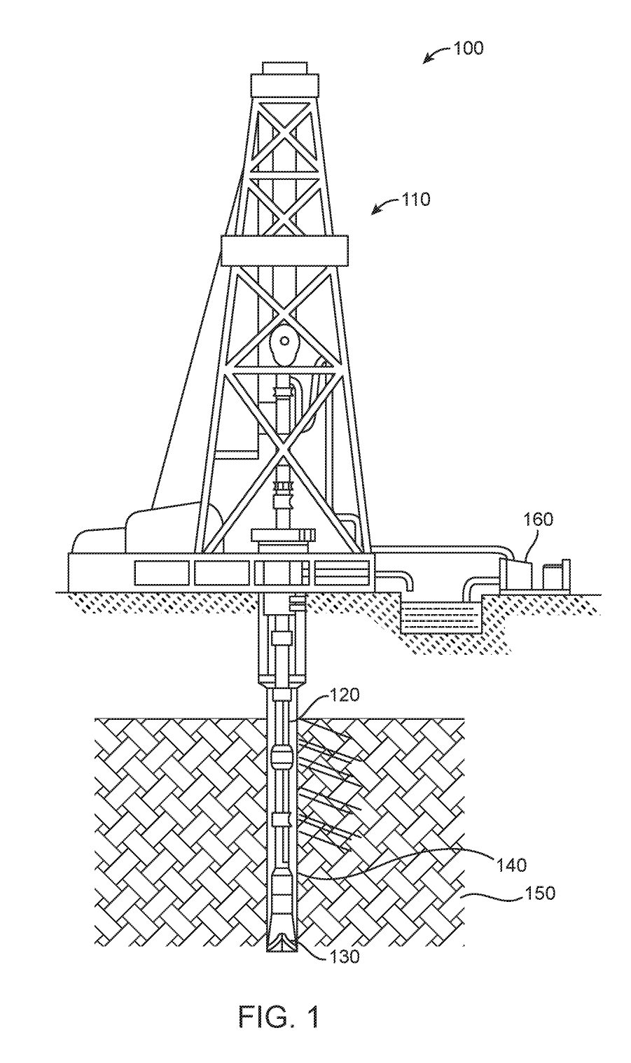

The wellbore ranging system and method can be employed in an exemplary drill system 100 shown, for example, in FIG. 1. Drill system 100 may include a drilling rig 110 and a drill string 120. A drill bit 130 can be provided at the lower end of the drill string 120. When a wellbore is being drilled, with for example a roller cone drill bit assembly, the drill bit 130 is rotated to create wellbore 140 in formation 150. The drill bit 130 is just one component of a bottom-hole assembly that typically includes one or more drill collars to provide weight and rigidity to aid the drilling process. Some of these drill collars include logging instruments to gather measurements of various drilling parameters such as position, orientation, weight-on-bit, borehole diameter, etc.

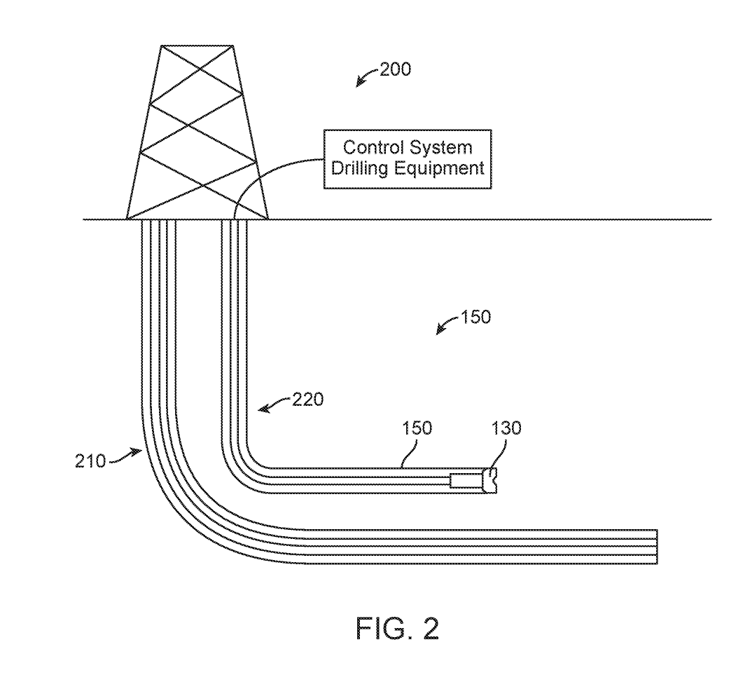

In many applications, such as steam assisted gravity drainage (SAGD) oilfield operations, determining the distance between horizontal wells becomes desirable, and methods such as logging-while-drilling (LWD) EM ranging for multiple wellbores are used. FIG. 2 depicts an example system 200 drilling two wellbores. It includes a drilling rig 110 extending over and around a completed wellbore 210 and a new wellbore 220. The wellbores 210 and 220 are within an earth formation 150. In applications such as these, the vertical separation between the wellbores should be kept within certain values (for example 4 to 6 meters) to better enable steam injection in the upper well (wellbore 220, in the example depicted) to mobilize oil within formation 150 for drainage into the lower producing well (wellbore 210, in the example depicted).

In SAGD operations, optimal wellbore placement and accurate relative placement between the steam injection and oil producing wells is desired. For efficient and economical production, the SAGD method typically attempts consistent separation and alignment between horizontal wells.

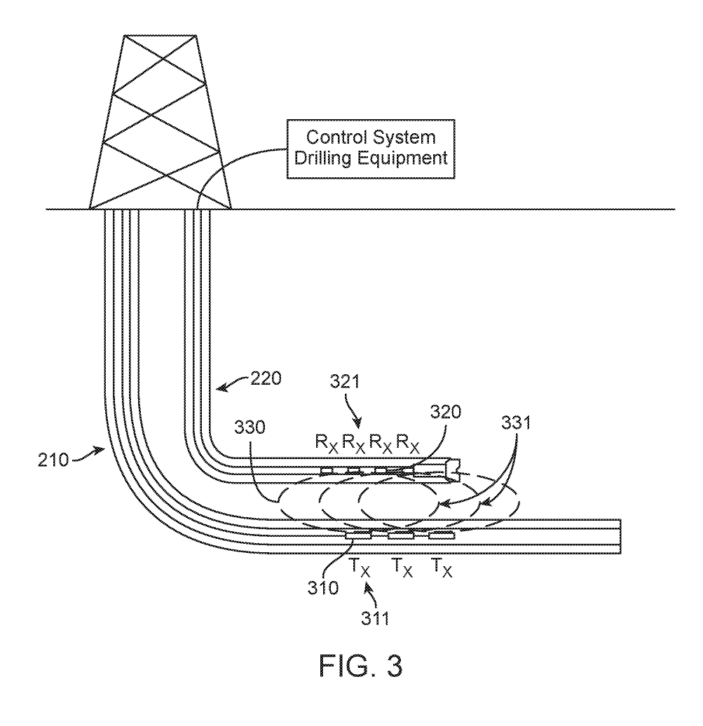

FIG. 3 depicts a well comparison assembly EM ranging method and system in accordance with the present disclosure to aide in the accurate placement of wellbores. In the depicted system, an array 310 of transmitters 311 is introduced into completed wellbore 210. An array 320 of receivers 321 is introduced into new wellbore 220. Transmitters 311 transmit signals 331, creating a field 330, which are received by receivers 321. In one example, each transmitter 311 is a solenoid generating an electromagnetic field, and the field is measured by the receivers 321. Each receiver 321 is able to measure the specific field 331 of a transmitter 311, allowing a measurement of each field 331 at multiple points. Analysis of the EM data collected at these multiple points can provide the direction and distance between the completed wellbore 210 and the new wellbore 220 as well as curvature of both wells.

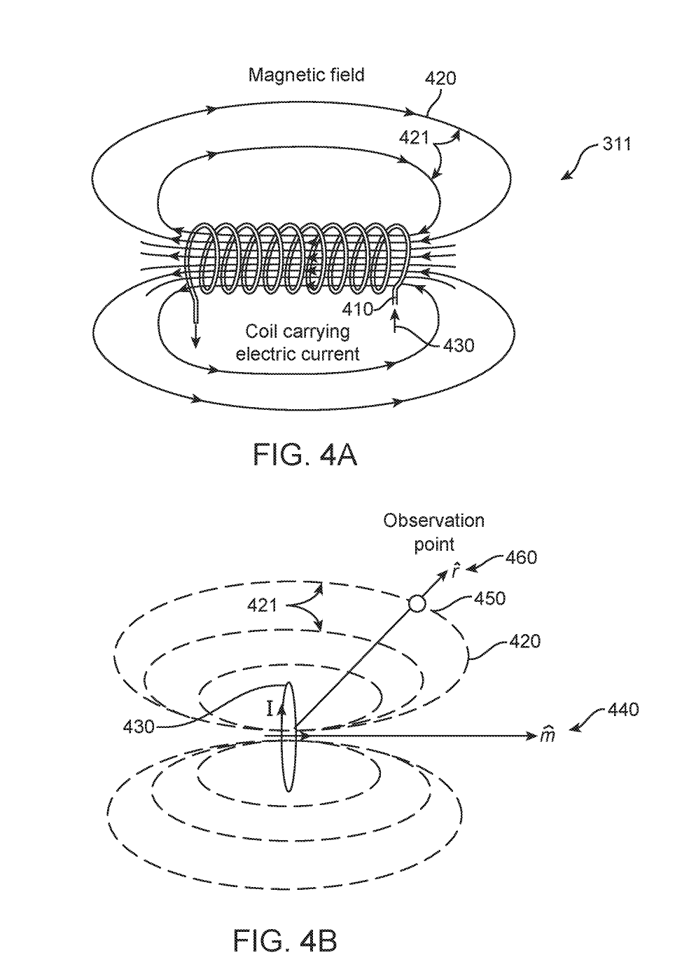

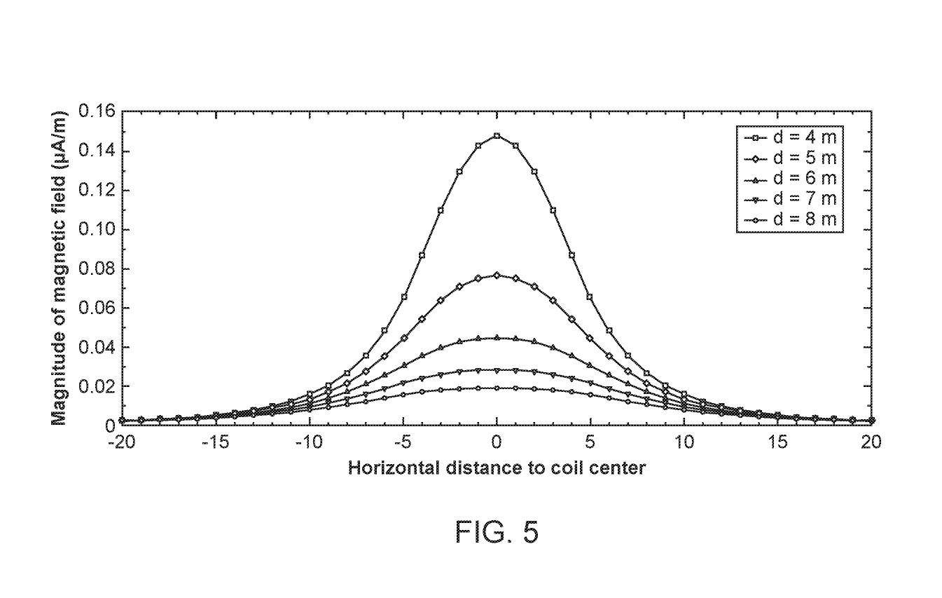

In one example, the transmitters 311 can be MGT tools as described above used as electromagnetic field sources introduced into the completed wellbore 210, and these electromagnetic fields can be sensed by any appropriate measurement-while-drilling (MWD) device introduced into the new wellbore 220 as receivers 321. When the MGT tool is energized, a magnetic field 331 of known strength and orientation is superimposed on the local magnetic field. The strength and orientation of this field is used to compute distance and direction between the MGT source in the completed wellbore 210 and the MWD sensors in the new wellbore 220. The magnetic field lines (421 in FIGS. 4A and B) generated by transmitter 311 will lie in the plane defined by transmitter 311 and the receiver 321. The direction of the radial component of the field relative to the new wellbore 220 (indicated by, for example, accelerometers in a typical MWD used as a receiver 321) determines the angle to the transmitter 311 and the completed wellbore 210. The strength of the radial and axial fields measured at a receiver 321 is used to compute the separation between the axis of the transmitter 311 and the receiver 321 as well as the depth differences between the receiver 321 and transmitter 311.

It is further possible to measure the magnetic field at different observation points on the drilling well simultaneously. A solenoid transmitter 311 will have a north-pole/south-pole magnetic field when energized. When it is introduced into completed wellbore 210 and three electromagnetic sensors (as receivers 321 in an array 320) are introduced into new wellbore 220, the receivers 321 will measure the magnetic field at the same time in three different positions. The measured data can then be analyzed to calculate the distance and direction to the first well as well as the curvature of both wells.

The magnetic field of a coil carrying current (such as a solenoid in an MGT tool) can be characterized by two magnetic poles separated by the tool length (typical lengths are on the order of ˜4.5 m). It may also be viewed as a coil consisting of a large number of circular loops stacking together. The field of the coil will be the summation of the fields of the constituent loops. The loop itself can be modeled by a magnetic dipole pointing in the direction \hat{m}, perpendicular to the loop and having strength of m=IA Weber meters, where I and A are the current and the area of the loop.

FIG. 4A depicts one example transmitter 311 that may be used. Transmitter 311 in FIG. 4A is a current carrying coil 410. Magnetic field 420 is created when current 430 flows through coil 410. FIG. 4B depicts the magnetic field 420 created by current 430, and the magnetic moment 440 of magnetic field 420. Observation point 450 is the location of one of the receivers, and a measurement at observation point 450 of the magnetic field 420 allows the calculation of radial vector 460.

In the example of a coil as a transmitter 311 introduced into completed wellbore 210, the field produced by the coil can be measures at different observation points in the new wellbore 220. The combination of results at these points provides information about the distance, direction, and curvature of the wells. Green's function calculations can then be applied to calculate the field of the coil consisting of a number of current loops.

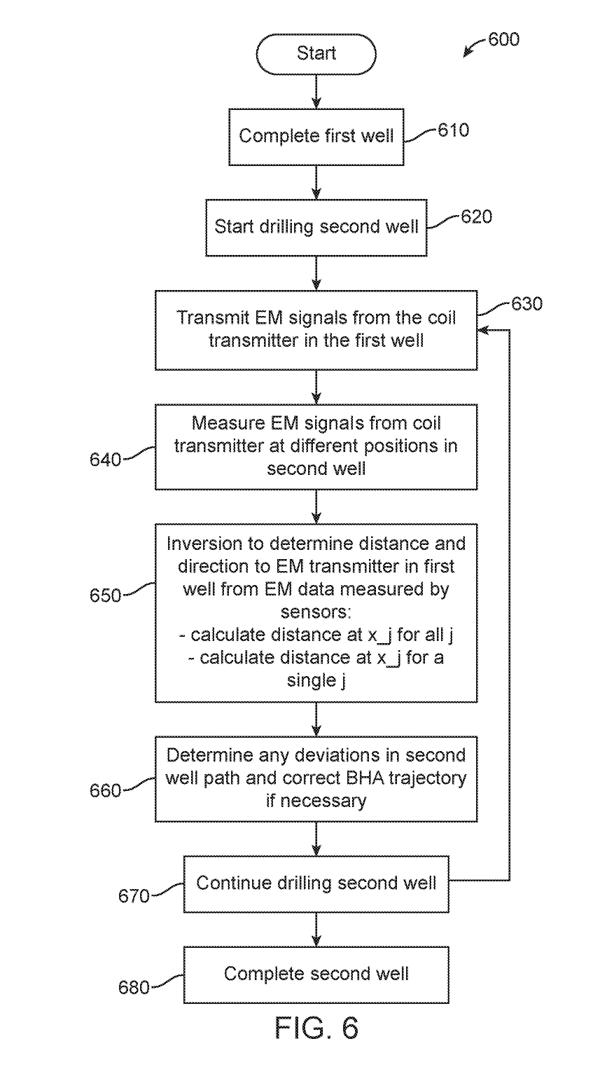

FIG. 5 depicts an example data collection from the measurement of a magnetic field 420 generated by a transmitter 310 introduced into completed wellbore 210 and measured in multiple locations. The horizontal axis shows the horizontal distance between each observation point (450 from FIG. 4B) and the transmitter 311. In the depicted example, the transmitter is a solenoid coil with total length of 4 m consisting of 500 loops having radius 5 cm, operated at 5 Hz with a current of 10 A. Thus, the formation has properties of ϵᵣ=μᵣ=1 and σ=0.05 S/m. As the graph depicts, the separation between the completed wellbore 210 of the example and the new wellbore 220 of the example, varies from d=4 m to 8 m. Measuring a magnetic field at different points along the wellbore allows a mapping of the measured data to the magnetic field curves, and thus the distance between the wellbores can be calculated.

By knowing the formation properties, one can calculate the magnetic field of a coil and obtain a magnetic field curve like FIG. 5. By measuring the field at multiple points and mapping them to the magnetic field curves, the distance between wellbores can be determined. In addition, an inversion algorithm based on the laws governing EM fields can be used to determine the position of the EM transmitter and curvature of the completed wellbore 210 or the new wellbore 220 from the array of EM sensors. This inversion algorithm may be based on deterministic and/or stochastic methods of optimization. Inversion may also be used to directly calculate the curvature of the completed wellbore 210 or the new wellbore 220 as opposed to deriving the curvature from multiple distance and direction measurements. Calculation of curvature directly from the field measurements provides a more accurate survey, since a curved model of a well could be used in the inversion. It also allows one to compare the calculated curvature with an expected curvature (which is obtained from a-priori or survey information), and produce a quality indicator. This quality indicator can be the ratio or difference of the calculated and expected curvatures. In this direct calculation, modeled magnetic fields curves similar to those in FIG. 5 may be constructed for different curvatures by running electromagnetic simulations with a curved well geometry. The curvature associated with the modeled magnetic fields curve that matches best with the magnetic fields from the measurements is selected as the estimated curvature. Electromagnetic simulations may be based on method of moments, finite difference, finite element, integral equations, semi-analytic formulations or any other method that is used to estimate the magnetic fields for a given well curvature.

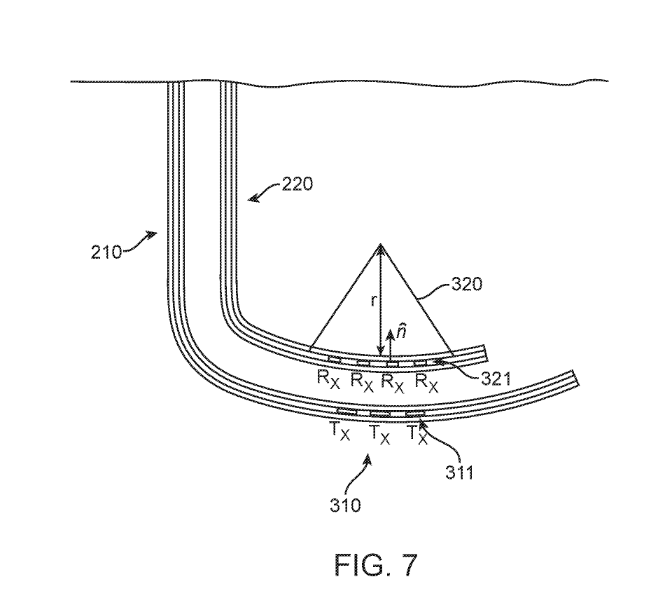

FIG. 6 is a workflow of an example methodology as disclosed. Flow 600 describes a basic method of utilizing transmitters and receivers for determining wellbore positioning and distance. A first wellbore is completed, 610, and a second wellbore is begun, 620. Transmitters are introduced into the completed wellbore, 630, and begin emitting EM signals. Measurements are made by receivers introduced into the new well, 640, at multiple locations. This can be done, for example, through the use of multiple measurements by a single transmitter or simultaneous measurements of an array of receivers. Inversion is conducted, 650, to determine the distance and direction of the transmitter with respect to the receiver location. Through this analysis, determinations can be made regarding the bottom hole assembly's (BHA) location, direction, distance, and curvature from the completed wellbore and alterations or corrections to the trajectory of the new wellbore can be made. A quality indicator can be calculated as a function of the calculated and estimates curvatures. Once the accuracy of the new borehole path is assured, the new borehole can be continued, 670, and completed 680.

As discussed above, the multiple position measurements of the signals from the transmitter(s) in the completed wellbore, or a single receiver can be introduced into the new wellbore and moved along the measure the magnetic field at different points. In the case of solenoidal transmitters, by reading the field data at least at three different positions, one can map the measured data to the magnetic field curve of the coil and calculate the distance between the wells. A fewer number of positions may be required for multi-axial transmitters with multiple collocated coils.

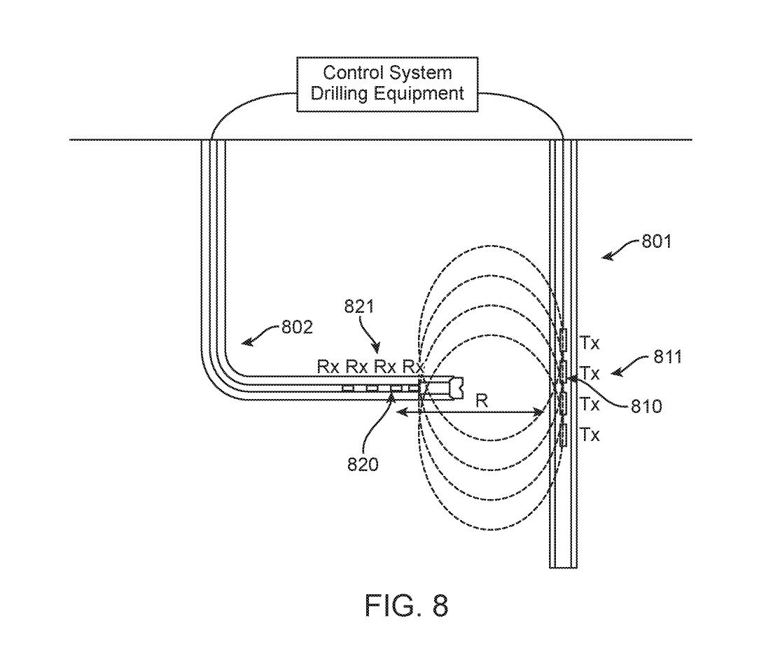

Also as discussed above, an array of transmitters can be introduced into the new wellbore. FIG. 7 depicts an example of an array 310 of coil transmitters 311 in completed wellbore 210. An array 320 of EM sensors 321 is deployed in the new wellbore 320 for EM ranging in a SAGD oilfield operation. The transmitters can be controlled separately. By using an array of transmitters, the operation will be faster. In addition, one can obtain the radius and azimuth of the well curvature by doing measurement in a single depth. Radius and azimuth may be calculated using the inversion method described earlier which relies on matching magnetic fields from multiple curved models to measurements and selecting the best match.

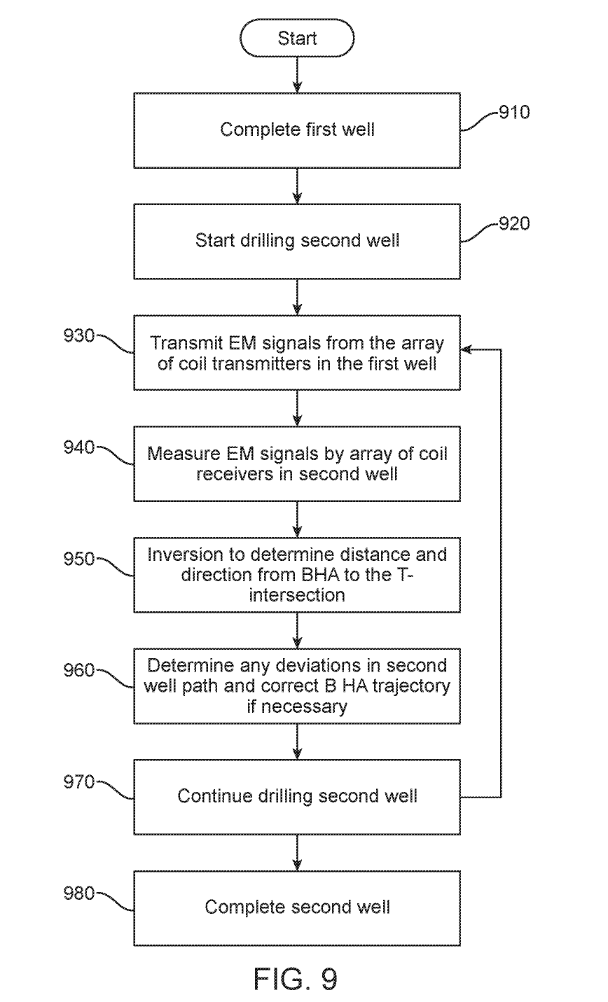

The methods and systems are not limited to wellbores in parallel arrangements. For example, FIG. 8 depicts an approximately perpendicular geometry illustrating an example T-intersection operation. In such a T-section operation an approximately horizontal wellbore is drilled to intersect an approximately vertical wellbore. In order to successfully complete such an operation precise placement and control is often required. As shown in FIG. 8, an array 820 of EM sensors 821 are arranged in a bottom hole assembly for a new wellbore 802 having an approximately horizontal orientation. Additionally, an array 810 of coil transmitters 811 are arranged inside a completed wellbore 801 having an approximately vertical orientation arranged for a T-intersection ranging operation. EM sensors 821 measure the magnetic fields, and the measured field data can be used to calculate the distance, direction, and curvature from the BHA relative to the completed well 801 in the T-intersection configuration. By using an array 810 of transmitters 811, one can control the signal of each transmitter. By comparing the signal at the receivers 821 coming from different transmitters 811, one can control the path of drilling. In the case of T-intersection, a magnetic field curve model similar to that shown in FIG. 5 may be obtained by utilizing an electromagnetic simulation model that includes a T-intersection.

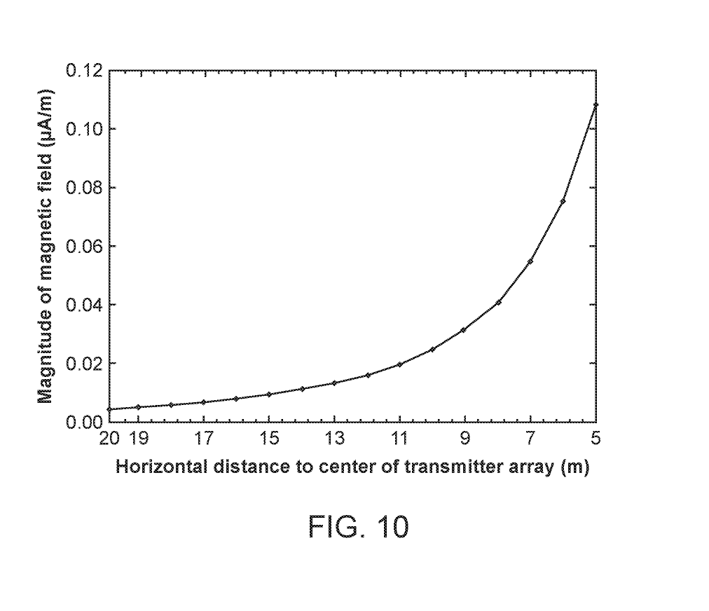

FIG. 9 depicts an example workflow for a system in such a T-intersection geometry. After a first wellbore has been completed, 910, and a new wellbore has begun, 920, a single transmitter or an array of transmitters is introduced into the completed wellbore and transmit, 930, EM signals. These signals are received, 940, at a receiver or array of receivers. Inversion is used, 950, to determine the distance and direction of the BHA in the new wellbore to the T-junction. From this analysis the intended path of the new wellbore can be adjusted or corrected, 960, the new wellbore continued 970, and completed 980.

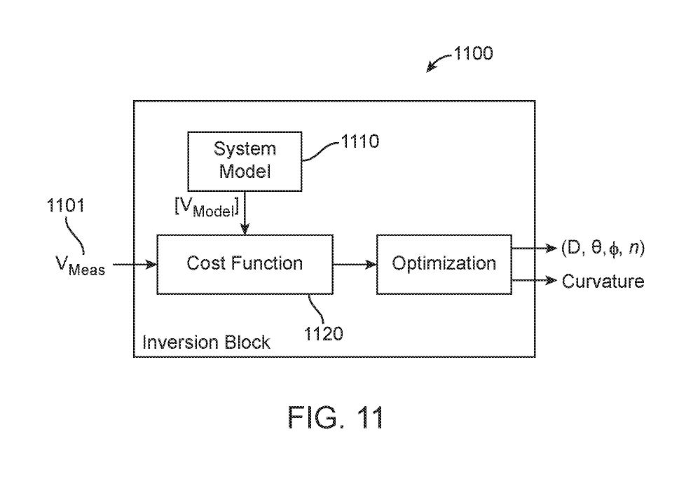

FIG. 10 illustrates graphically an example relationship between the magnitude of a magnetic field and the distance between T-intersecting wells such as those shown in FIG. 8. For example, using the relationship such as that shown in FIG. 10, the magnitude of a magnetic field measured by an array of sensors in a horizontal well such as wellbore 802 in FIG. 8 can be used to determine the distance to an array of transmitters generating the magnetic field in a vertical wellbore such as wellbore 801 in FIG. 8. To generate the graph as shown in FIG. 10, several characteristics may be provided, such as characteristics of the formation and characteristics of the array of transmitters in order to gage the magnitude of the magnetic field as a function of distance.

As an example, with an array of transmitters in a vertical well, such as the array 811 of coil transmitters 810 in wellbore 801, if the array has four coils separated by 5 m, each coil having a total length of 4 m and consisting of 500 loops with a radius of 5 cm, operated at 5 Hz with a current of 10 A, and the formation has properties of ε_r=μ_r=1 and σ=0.05 S/m, the plot in FIG. 10 showing the relationship of magnitude of the magnetic field as a function of distance to an array of transmitters can be generated. Based on this graph, if the sensors in a horizontal well, such as array 820 of EM sensors 821 in FIG. 8, detect a particular magnitude recited in the vertical axis FIG. 10, this can then be related to the distance to the center of an array of transmitters in the vertical wellbore recited in the horizontal axis of FIG. 10. Therefore, during a T-intersection operation and using the plot in FIG. 10, an operator can determine the distance from a horizontal well to a vertical well by measuring the magnitude of the magnetic field generated by transmitters in a vertical well.

The signal data obtained from the systems described herein can be used in an inversion algorithm to determine well parameters. FIG. 11 shows an example block diagram 1100 for an example inversion process. The sensor measurements are represented by Vmeas 1101. The signal data that comes from the system model 1110 is represented by Vmodel 1111. The optimization algorithm tries to match Vmeas 1101 and Vmodel 1111 by making iterative estimations and minimizing a cost function 1120 to obtain the unknown well parameters.

The distance D, inclination angle θ, azimuth angle ϕ, target well orientation \hat{n}, and curvature can be found by this process, if a sufficiently diverse set of measurements is provided. For example, if only D and θ are unknown, two measurements are sufficient for inversion. Transmitters and receivers located at different depths/locations provide the required measurements. If ϕ is unknown as well, multiple measurements at different rotation angles can be used in the inversion to uniquely compute ϕ. In case \hat{n} vector is unknown, it can be found out by including multiple depth information of multiple transmitters/receives. Curvature is found using, for example, the methodology described herein.

In the above description, reference to up or down is made for purposes of description with “up,” “upper,” “upward,” “uphole,” or “upstream” meaning toward the surface of the wellbore and with “down,” “lower,” “downward,” “downhole,” or “downstream” meaning toward the terminal end of the well, regardless of the wellbore orientation. Correspondingly, the transverse, axial, lateral, longitudinal, radial, etc., orientations shall mean orientations relative to the orientation of the wellbore or tool. The term “axially” means substantially along a direction of the axis of the object. If not specified, the term axially is such that it refers to the longer axis of the object.

Several definitions that apply throughout the above disclosure will now be presented. The term “coupled” is defined as connected, whether directly or indirectly through intervening components, and is not necessarily limited to physical connections. The connection can be such that the objects are permanently connected or releasably connected. The term “outside” or “outer” refers to a region that is beyond the outermost confines of a physical object. The term “inside” or “inner” refers to a region that is within the outermost confines of a physical object. The terms “comprising,” “including” and “having” are used interchangeably in this disclosure. The terms “comprising,” “including” and “having” mean to include, but not necessarily be limited to the things so described.

Numerous examples are provided herein to enhance understanding of the present disclosure. A specific set of statements are provided as follows.

Statement 1: A method of well ranging, comprising: generating at least two electromagnetic fields at different axial locations within a first well bore; measuring the fields from at least one axial location within a second well bore; and calculating, using the measurements, at least one of distance, direction, and curvature of the second well bore with respect to the first well bore.

Statement 2: The method of well ranging of Statement 1 further comprising: directing an intended path of the second well bore substantially parallel to the shaft of the first well bore.

Statement 3: The method of well ranging of Statements 1 and 2 further comprising: directing an intended path of the second well bore substantially perpendicular to the first well bore.

Statement 4: The method of well ranging of Statements 1-3 further comprising: generating the at least one field with a direct current capable of being alternated in sign.

Statement 5: The method of well ranging of Statement 4 further comprising: eliminating an effect of Earth's magnetic field by subtracting a measurement a field when the sign of the direct current generating it is positive from a measurement of the field when the sign of the direct current generating it is negative.

Statement 6: The method of well ranging of Statements 1-5 comprising measurements at more than one axial location.

Statement 7: The method of well ranging of Statement 6 wherein a ratio of measurements is used to calculate the at least one of distance, direction or curvature.

Statement 8: The method of well ranging of Statements 1-7 wherein calculation of curvature is performed by using measurements of a field generated from a single axial location.

Statement 9: The method of Statements 1-8 wherein curvature is calculated using inversion.

Statement 10: The method of Statement 9 wherein curvature is calculated using modeling of magnetic field curves from electromagnetic simulations.

Statement 11: The method of Statement 10 wherein the calculated curvature is compared to an expected curvature.

Statement 12: A method of well comparison, comprising: generating at least one electromagnetic field within a first well bore; measuring the magnetic field at a plurality of axial locations within a second wellbore; and calculating from these measurements a curvature of the second well bore with respect to first wellbore.

Statement 13: A system for well comparison, comprising: a plurality of electromagnetic field generators shaped for insertion into a first well; at least one electromagnetic field detector shaped for insertion into a second well and capable of measuring the fields; and wherein measurements of the fields generated by the generators by the at least one detector can be used to calculate at least one of distance, direction and curvature of the second well with respect to the first well.

Statement 14: The system for well comparison of Statement 13 wherein calculation of curvature is performed by using field from a single field detector.

Statement 15: The system for well comparison of Statements 13 and 14 wherein the calculation includes an inversion using the measured fields.

Statement 16: The system for well comparison of Statement 15 wherein curvature is calculated using modeling of magnetic field curves from electromagnetic simulations.

Statement 17: The system for well comparison of Statements 13-16 wherein the transmitters are single axis solenoids or coils.

Statement 18: The system for well comparison of Statements 13-16 wherein the generators are multi-axis solenoids or coils.

Statement 19: The system for well comparison of Statements 13-18 wherein the generators are energized with a direct current or alternating current.

Statement 20: The system for well comparison of Statements 13-19 wherein a sign of the current is alternated.

Statement 21: The system for well comparison of Statement 20 wherein an effect of Earth's magnetic field is eliminated.

Statement 22: The system for well comparison of Statement 21 wherein the effect of Earth's magnetic field is eliminated by subtracting the measurement by the at least one detector of the field generated by one of the plurality of generators when the sign of the direct current energizing the generator is positive from the measurement by the at least one detector of the field of the same generator when the sign of the direct current energizing the generator is negative.

Statement 23: The system for well comparison of Statements 13-22 wherein the at least one receiver is a single axis magnetometer.

Statement 24: The system for well comparison of Statements 13-22 wherein the at least one receiver is a multi-axis magnetometer.

Statement 25: The system for well comparison of Statements 13-24 wherein a ratio of measurements of fields generated at different axial locations in the first well is capable of being used to calculate at least one of distance, direction and curvature of the second well with respect to the first well.

Statement 26: The system for well comparison of claim 25 further comprising a quality indicator calculated from a comparison of the calculated curvature and an expected curvature.

Statement 27: The system for well comparison of Statements 13-26 further comprising: at least one additional electromagnetic field detector; and wherein a ratio of measurements from the at least one detector and the at least one additional detector of a single chosen generator is capable of being used to calculate the at least one of distance, direction or curvature.

Statement 28: A system for well comparison, comprising: at least one electromagnetic field generator shaped for insertion into a first well and capable of generating an electromagnetic field; at least one detector capable of measuring in the second well the field generated in the first well; wherein the first well is substantially perpendicular to the second well; and wherein measurements of the field of the at least one generator are capable of being used to calculate a distance, direction or curvature of the second well with respect to the first well.

Statement 29: The system for well comparison of Statement 28 wherein the calculation includes an inversion of the measurements of the field.

Statement 30: The system for well comparison of Statements 28 and 29 wherein the at least one generator is a single axis solenoid or coil.

Statement 31: The system for well comparison of Statements 28 and 29 wherein the at least one generator is a multi-axis solenoid or coil.

Statement 32: The system for well comparison of Statements 28-31 wherein the at least one generator is energized with a direct current or alternating current.

Statement 33: The system for well comparison of Statement 32 wherein a sign of the current is alternated.

Statement 34: The system for well comparison of Statement 33 wherein an effect of Earth's magnetic field is eliminated.

Statement 35: The system for well comparison of Statement 34 wherein the effect of Earth's magnetic field is eliminated by subtracting a measurement of the field of the at least one generator when the sign of the direct current is positive from a measurement of the field of the at least one generator when the sign of the direct current is negative.

Statement 36: The system for well comparison of Statements 28-35 wherein the at least one detector is a single axis magnetometer.

Statement 37: The system for well comparison of Statements 28-36 wherein the at least one detector is a multi-axis magnetometer.

Statement 38: The system for well comparison of Statements 28-37 further comprising: at least one additional electromagnetic field generator shaped for insertion into the first well bore and capable of generating an additional field; and wherein the fields are measured by the at least one detector and a ratio of the measurements of the fields are capable of being used to calculate the distance, direction or curvature of the second well with respect to the first.

Statement 39: The system for well comparison of Statement 28-38 further comprising: at least one additional detector capable of measuring in the second well fields generated in the first well; and wherein when the field of the at least one generator is measured by the at least one detector and the at least one additional detector and a ratio of the measurements is capable of being used to calculate a distance, direction or curvature of the second well in relations to the first well.

Statement 40: The system for well comparison of Statements 28-39 wherein curvature is calculated using inversion.

Statement 41: The system for well comparison of Statement 39 wherein curvature is calculated using modeling of magnetic field curves from electromagnetic simulations.

Statement 42: The system for well comparison of Statement 41 wherein a quality indicating ratio is generated using the calculated curvature and an expected curvature.

Statement 43: A system for well comparison, comprising: at least one electromagnetic field generator shaped for insertion into a first well and capable of generating a field; at least one detector capable of measuring the field in a second well; and wherein measurements in the second well by the detector of the field generated in the first well are capable of being used to calculate the curvature of the second well with respect to the first.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

1. A method of well ranging, comprising:
generating at least two electromagnetic fields at different axial locations within a first well bore;
measuring the fields from at least one axial location within a second well bore; and
calculating, using the measurements, at least one of distance, direction, and curvature of the second well bore with respect to the first well bore.

2. The method of claim 1 further comprising:
directing an intended path of the second well bore substantially parallel to the shaft of the first well bore.

3. The method of claim 1 further comprising:
directing an intended path of the second well bore substantially perpendicular to the first well bore.

4. The method of claim 1 further comprising:
generating the at least one field with a current capable of being alternated in sign.

5. The method claim 4 further comprising:
eliminating an effect of Earth's magnetic field by subtracting a measurement a field when the sign of the direct current generating it is positive from a measurement of the field when the sign of the direct current generating it is negative.

6. The method of claim 1 comprising measurements at more than one axial location.

7. The method of claim 6 wherein a ratio of measurements is used to calculate the at least one of distance, direction or curvature.

8. The method of claim 1 wherein calculation of curvature is performed by using measurements of a field generated from a single axial location.

9. The method of claim 1 wherein curvature is calculated using inversion.

10. The method of claim 9 wherein curvature is calculated using modeling of magnetic field curves from electromagnetic simulations.

11. The method of claim 10 wherein the calculated curvature is compared to an expected curvature.

12. A method of well comparison, comprising:
generating at least one electromagnetic field within a first well bore;
measuring the magnetic field at a plurality of axial locations within a second wellbore; and
calculating from these measurements a curvature of the second well bore with respect to first wellbore.

13. A system for well comparison, comprising:
a plurality of electromagnetic field generators shaped for insertion into a first well;
at least one electromagnetic field detector shaped for insertion into a second well and capable of measuring the fields; and
wherein measurements of the fields generated by the generators by the at least one detector can be used to calculate at least one of distance, direction and curvature of the second well with respect to the first well.

14. The system of claim 13 wherein calculation of curvature is performed by using field from a single field detector.

15. The system of claim 13 wherein the calculation includes an inversion using the measured fields.

16. The system of claim 15 wherein curvature is calculated using modeling of magnetic field curves from electromagnetic simulations.

17. The system of claim 13 wherein the generators are single axis solenoids or coils.

18. The system of claim 13 wherein the generators are multi-axis solenoids or coils.

19. The system of claim 13, wherein the generators are energized with a direct current or alternating current.

20. The system of claim 19 wherein a sign of the current is alternated.

21. The system of claim 20 wherein an effect of Earth's magnetic field is eliminated.

22. The system of claim 21 wherein the effect of Earth's magnetic field is eliminated by subtracting the measurement by the at least one detector of the field generated by one of the plurality of generators when the sign of the direct current energizing the generator is positive from the measurement by the at least one detector of the field of the same generator when the sign of the direct current energizing the generator is negative.

23. The system of claim 13 wherein the at least one detector is a single axis magnetometer.

24. The system of claim 13 wherein the at least one detector is a multi-axis magnetometer.

25. The system of claim 13 wherein a ratio of measurements of fields generated at different axial locations in the first well is capable of being used to calculate at least one of distance, direction and curvature of the second well with respect to the first well.

26. The system of claim 25 further comprising a quality indicator calculated from a comparison of the calculated curvature and an expected curvature.

27. The system of claim 13 further comprising:
at least one additional electromagnetic field detector; and
wherein a ratio of measurements from the at least one detector and the at least one additional detector of a single chosen generator is capable of being used to calculate the at least one of distance, direction or curvature.

28. A system for well comparison, comprising
at least one electromagnetic field generator shaped for insertion into a first well and capable of generating an electromagnetic field;
at least one detector capable of measuring in the second well the field generated in the first well;
wherein the first well is substantially perpendicular to the second well; and
wherein measurements of the field of the at least one generator are capable of being used to calculate a distance, direction or curvature of the second well with respect to the first well.

29. The system of claim 28 wherein the calculation includes an inversion of the measurements of the field.

30. The system of claim 28 wherein the at least one generator is a single axis solenoid or coil.

31. The system of claim 28 wherein the at least one generator is a multi-axis solenoid or coil.

32. The system of claim 28 wherein the at least one generator is energized with a direct current or alternating current.

33. The system of claim 32 wherein a sign of the current is alternated.

34. The system of claim 33 wherein an effect of Earth's magnetic field is eliminated.

35. The system of claim 34 wherein the effect of Earth's magnetic field is eliminated by subtracting a measurement of the field of the at least one generator when the sign of the direct current is positive from a measurement of the field of the at least one generator when the sign of the direct current is negative.

36. The system of claim 28 wherein the at least one detector is a single axis magnetometer.

37. The system of claim 28 wherein the at least one detector is a multi-axis magnetometer.

38. The system of claim 28 further comprising:
at least one additional electromagnetic field generator shaped for insertion into the first well bore and capable of generating an additional field; and
wherein the fields are measured by the at least one detector and a ratio of the measurements of the fields are capable of being used to calculate the distance, direction or curvature of the second well with respect to the first.

39. The system of claim 28 further comprising:
at least one additional detector capable of measuring in the second well fields generated in the first well; and
wherein when the field of the at least one generator is measured by the at least one detector and the at least one additional detector and a ratio of the measurements is capable of being used to calculate a distance, direction or curvature of the second well in relations to the first well.

40. The system of claim 28 wherein curvature is calculated using inversion.

41. The system of claim 40 wherein curvature is calculated using modeling of magnetic field curves from electromagnetic simulations.

42. The system of claim 41 wherein a quality indicating ratio is generated using the calculated curvature and an expected curvature.

43. A system for well comparison, comprising:
at least one electromagnetic field generator shaped for insertion into a first well and capable of generating a field;
at least one detector capable of measuring the field in a second well; and
wherein measurements in the second well by the detector of the field generated in the first well are capable of being used to calculate the curvature of the second well with respect to the first.
